(19) United States
(12) Patent Application Publication
(10) Pub. No.: US 2026/0368473 A1
(43) Pub. Date: Nov. 19, 2026

(54) IMPLEMENTING ARTIFICIAL INTELLIGENCE MODELS FOR CONVERSATION SYSTEM USES

(71) Applicant: International Business Machines Corporation, Armonk, NY (US)

(72) Inventors: Puspendu Chatterjee, NORTH TWENTY FOUR PARGANAS (IN); Ilan Sezhiyan Jayaraman, Bangalore (IN); Bidhu Ranjan Sahoo, Bangalore (IN)

(21) Appl. No.: 19/211,621

(22) Filed: May 19, 2025

(51) Int. Cl. G06N 3/006; G06N 3/045

(52) U.S. Cl. CPC G06N 3/006; G06N 3/045

(57) ABSTRACT

A computer-implemented method includes processing, using multiple artificial intelligence models, at least one set of validation data related to at least one designated automated conversation system task; evaluating, based at least in part on the processing of the at least one set of validation data, performance of the multiple artificial intelligence models using a weighted combination of two or more similarity measures in conjunction with one or more performance metrics; selecting, based at least in part on the evaluating of the performance of the multiple artificial intelligence models, one of the multiple artificial intelligence models to be used in executing at least one instance of the at least one designated automated conversation system task; and performing one or more automated actions based at least in part on the selecting of one of the multiple artificial intelligence models.

### BACKGROUND

The present application generally relates to information technology, and to evaluating and configuring artificial intelligence models. Conventional artificial intelligence approaches commonly fail to consistently assess the effectiveness of different models across different tasks, which can result in errors with respect to model fit and decreases in model performance.

In at least one embodiment, an example computer-implemented method includes processing, using multiple artificial intelligence models, at least one set of validation data related to at least one designated automated conversation system task, and evaluating, based at least in part on the processing of the at least one set of validation data, performance of the multiple artificial intelligence models using a weighted combination of two or more similarity measures in conjunction with one or more performance metrics. The method also includes selecting, based at least in part on the evaluating of the performance of the multiple artificial intelligence models, one of the multiple artificial intelligence models to be used in executing at least one instance of the at least one designated automated conversation system task. Further, the method additionally includes performing one or more automated actions based at least in part on the selecting of one of the multiple artificial intelligence models.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example system architecture for artificial intelligence model evaluation, according to an example embodiment of the invention;

FIG. 2 is a diagram illustrating an example system architecture for model output similarity computations, according to an example embodiment of the invention;

FIG. 3 is a flow diagram illustrating techniques according to an example embodiment of the invention; and

FIG. 4 is a diagram illustrating a computing environment in which at least one embodiment of the invention can be implemented.

### DETAILED DESCRIPTION

As described herein, at least one embodiment includes tailoring artificial intelligence models, including large language models (LLMs) and/or natural language processing (NLP) models for targeted performance assessment in connection with conversation systems. Such an embodiment can include generating and/or implementing at least one model-based comparison technique which leverages weighted combinations of similarity measures including, for example, semantic similarity, content similarity, syntactic similarity, and/or contextual similarity, to determine and/or generate output similarity computations across multiple artificial intelligence models for one or more particular use cases and/or tasks (e.g., a weightage scheme designating content similarity weighted as 40% of the total output similarity computation score, semantic similarity weighted as 20% of the total output similarity computation score, contextual similarity weighted as 25% of the total output similarity computation score, and syntactic similarity weighted as 15% of the total output similarity computation score).

For example, one or more embodiments include computing, for multiple artificial intelligence models, model output and validation output using embedding techniques and a cosine similarity function, wherein such outputs are used to calculate the semantic similarity of the model outputs with designated validation data. Further, such an embodiment can include computing model output and validation output using tokenization techniques and a Jaccard similarity function, wherein such outputs are used to calculate the content similarity of the model outputs with designated validation data. Additionally, such an embodiment can include computing model output and validation output using positional sequencing techniques and at least one NLP function, wherein such outputs are used to calculate the syntactic similarity of the model outputs with designated validation data. Also, such an embodiment can include computing model output and validation output using tokenization techniques, contextual embedding techniques, and a cosine similarity function, wherein such outputs are used to calculate the contextual similarity of the model outputs with designated validation data. Further, using at least a portion of the above-noted computations, such an embodiment can include determining and/or generating at an output similarity computation score for at least a portion of the artificial intelligence models based at least in part on a weightage scheme (e.g., a weightage scheme aligned and/or configured for a given conversational system).

Additionally or alternatively, at least one embodiment can include using the median of the output similarity computation scores for a given one of the artificial intelligence models for different validation inputs to calculate a computed similarity score for the given artificial intelligence model. Such an embodiment can also include repeating the above-noted process for one or more of a candidate set of artificial intelligence models, and selecting one such model for use in connection with the given conversation system and/or task based at least in part on which model corresponds with the highest median similarity score.

As detailed herein, one or more embodiments can include implementation across multiple NLP models and/or multiple LLMs. By way merely of example, such NLP models can include Word2Vec, global vectors for word representation (GloVe), fastText, embeddings from language models (ELMo), universal language model fine-tuning (ULMFiT), bidirectional encoder representations from transformers (BERT), generative pre-trained transformers (GPTs), transformer-XL, XLNet, robustly optimized BERT pretraining approach (RoBERTa), text-to-text transfer transformer (T5), a lite BERT (ALBERT), efficiently learning an encoder that classifies token replacements accurately (ELECTRA), conditional transformer language model (CTRL), multilingual neural machine translation (MarianMT), cross-lingual language model – RoBERTa (XLM-R), etc. Also, such LLMs can include, for example, one or more GPTs, DaVinci, codex, Ada, pathways language model (PaLM), language model for dialogue applications (LaMDA), Llama, etc.

Determining whether a particular model being used for a specific task is successful can depend, for example, on whether the evaluation metric(s) being used is correct and/or appropriate for the given use case, and whether the correct and/or appropriate evaluation process is being follows. Also, the evaluation metric(s) being used can vary based at least in part on the type of use case. Accordingly, one or more embodiments include categorizing evaluation metrics into multiple categories include, for example, an intrinsic evaluation category (which focuses on one or more intermediary objectives such as, e.g., the performance of the model on a defined subtask), and an extrinsic evaluation category (which focuses on the performance of a final objective such as, e.g., the performance of the model on the complete task and/or application).

Evaluation metrics classified as belonging to the intrinsic evaluation category can include, for example, accuracy, precision and recall, area under the curve (AUC), mean reciprocal rank (MRR), mean average precision (MAP), root mean squared error (RMSE), mean absolute percentage error (MAPE), the metric for evaluation of translation with explicit ordering (METEOR), F1 score, bilingual evaluation understudy (BLEU), recall-oriented understudy for gisting evaluation (ROUGE), perplexity, etc.

More particularly, in an example embodiment, accuracy measures overall correctness of model predictions or classifications, and precision and recall are used for evaluating models on tasks such as information retrieval, question answering, sentiment analysis, etc. Precision measures the proportion of correctly identified positive instances, while recall measures the proportion of actual positive instances correctly identified. Also, AUC helps quantify a model’s ability to separate classes by capturing the count of positive predictions which are correct against the count of positive predictions that are incorrect at one or more different thresholds.

Further, in an example embodiment, MRR evaluates the responses retrieved, in correspondence to a query, given their probability of correctness. The MRR evaluation metric is often used in informational retrieval tasks. Also, similar to MRR, MAP calculates the mean precision across each retrieved result. MAP is also commonly used in information retrieval tasks for ranked retrieval results.

When the predicted outcome is a real value, RMSE can be used. Additionally or alternatively, RMSE can be used in conjunction with MAPE in the case of regression problems, wherein MAPE is the average absolute percentage error for each data point when the predicted outcome is continuous. Also, METEOR is a precision-based metric for the evaluation of machine translation output, and a METEOR score allows synonyms and stemmed words to be matched with at least one reference word. BLEU is also primarily used for evaluating machine translation models, wherein BLEU compares the generated translation against one or more reference translations and computes a similarity score based on n-gram matches.

Further, F1 score combines precision and recall into a single metric, providing a balanced measure of a model’s performance on tasks with imbalanced classes. ROUGE evaluates the quality of a text summarization model by comparing a generated summary against one or more reference summaries, and perplexity is often used to evaluate language models by measuring how well a model predicts a sample text (wherein lower perplexity indicates better performance).

Evaluation metrics classified as belonging to the extrinsic evaluation category can include, for example, task-specific accuracy or performance, key performance indicators (KPIs), one or more user satisfaction metrics, time and resource efficiency, return on investment (ROI), etc. More particularly, in an example embodiment, task-specific accuracy or performance can measure how well a given model performs on the specific task that the model has been designed for and/or asked to complete, such as sentiment analysis accuracy, machine translation BLEU score, question answering accuracy, etc.

Also, KPIs evaluate a model’s impact on one or more enterprise and/or user goals, such as engagement, conversion rates, revenue generation, etc. User satisfaction metrics can include, for example, user surveys, user feedback, user experience measures, etc. wherein such metrics can be used to assess a model’s usability, effectiveness, and/or overall satisfaction from the perspective of the end users. Time and resource efficiency can evaluate how efficiently the model performs in terms of inference time, memory usage, energy consumption, etc. Further, ROI assesses the model’s effectiveness in terms of cost savings, productivity improvement, value generated, etc.

Accordingly, based at least in part on at least a portion of the above-noted intrinsic and extrinsic metrics, one or more embodiments can include performing model comparison across two or more artificial intelligence models using intrinsic and extrinsic matrixes for each model, and determining and/or selecting the best model for a particular use case based thereon. Such a comparison can enable the identification of one or more strengths and/or one or more weaknesses of each model under consideration across one or more tasks and/or applications. As such, the evaluation framework of one or more embodiments can be implemented in a task-specific manner with respect to multiple different LLM and/or NLP tasks (such as, for example, sentiment analysis, machine translation, text summarization, question answering, etc.). This provides insights into model performance on specific tasks, which can facilitate selection of the most suitable model for particular tasks and/or use cases.

At least one embodiment can also include leveraging one or more established benchmarks and/or datasets to provide one or more standardized evaluation metrics, enabling comparisons between models and providing benchmarks for monitoring and/or processing performance improvements. Further, one or more embodiments include enabling users to customize evaluations, for example, by enabling users to define and/or select one or more particular evaluation metrics and/or criteria based at least in part on specific use case-related requirements. Also, such an embodiment can include updating the evaluation framework with new models and metrics, reinforcing the framework’s scalability by accommodating multiple models, datasets, and, metrics.

Accordingly, and as further detailed herein, at least one embodiment includes evaluating the performance of at least one NLP model and/or at least one LLM via the following actions. For example, such actions include performing exploratory data analysis, wherein data (e.g., labeled data, structured data, and/or unstructured data for model training) is collected and/or obtained and subsequently preprocessed for evaluation. The preprocessing can include, for example, cleaning at least a portion of the data, removing noise from at least a portion of the data, handling missing values within the data, and/or splitting at least a portion of the data into training and testing sets to be used, e.g., in determining one or more patterns in the data.

Such an embodiment also includes selecting one or more performance metrics to be used in the evaluation. Selecting the one or more performance metrics can include, for example, determining one or more appropriate, user-preferred, and/or system-compatible metrics based at least in part on the specific task being asked of a set of NLP models and/or a set of LLMs and one or more goals of the task. Such performance metrics can include, for example, the distance in between the model outputs. By way of illustration, suppose two LLMs are generating two different answers for a chosen question, and that a baseline answer set for the same question also exists. As part of the determining such metrics, at least one embodiment can include calculating the distance between the baseline and model-1_output, and similarly the distance between the baseline and model-2_output. The model providing the output having the least distance from the baseline can be considered as the better model in this instance.

Also, such an embodiment includes training the set of NLP models and/or the set of LLMs using the prepared and/or preprocessed training dataset. The training can include, for example, feeding the set of NLP models and/or the set of LLMs with the input data (that is, at least a portion of the training dataset), modifying and/or optimizing one or more model parameters, and adjusting one or more model hyperparameters in connection with the training.

Such an embodiment additionally includes evaluating the set of NLP models and/or the set of LLMs by applying the trained model to the prepared and/or preprocessed testing dataset and evaluating the model performance using the one or more selected performance metrics. The evaluation can provide one or more insights into how well the set of NLP models and/or the set of LLMs generalizes to new and/or unseen data and performs the specific task at hand. Further, such an embodiment includes analyzing the evaluation results to determine one or more model strengths, one or more model weaknesses, and/or one or more areas for model improvement. This analysis can include, for example, identifying one or more similarities (as further detailed herein), one or more errors, and/or one or more biases in the model predictions.

Additionally, such an embodiment can also include, based at least in part on the evaluation and analysis thereof, refining, configuring, and/or iterating on the set of NLP models and/or the set of LLMs by adjusting one or more portions of the model architecture, fine-tuning one or more model parameters, increasing training data for the model, and/or using one or more advanced techniques such as, e.g., transfer learning. In such an embodiment, instead of training a model from scratch for a new task, which can be time-consuming and require a large amount of data, transfer learning leverages the pre-trained model’s learned features and weights as a starting point.

Also, such an embodiment can further include comparing the evaluated model performance against one or more existing benchmarks and/or performance metrics of one or more other models with respect to the task in question. This comparison can provide a broader context for assessing the relative strengths and/or weaknesses of the set of NLP models and/or the set of LLMs, and can be leveraged in connection with selecting a particular model for a future execution of the task in question. By way of example, at least one embodiment can include determining and outputting, to at least one system and/or user related to the task, one or more recommendations as to at least one particular model to be used in connection with executing the task. Additionally or alternatively, one or more embodiments can automatically select, based at least in part on such a recommendation, a particular NLP model and/or LLM, and automatically execute the task using the selected NLP model and/or LLM.

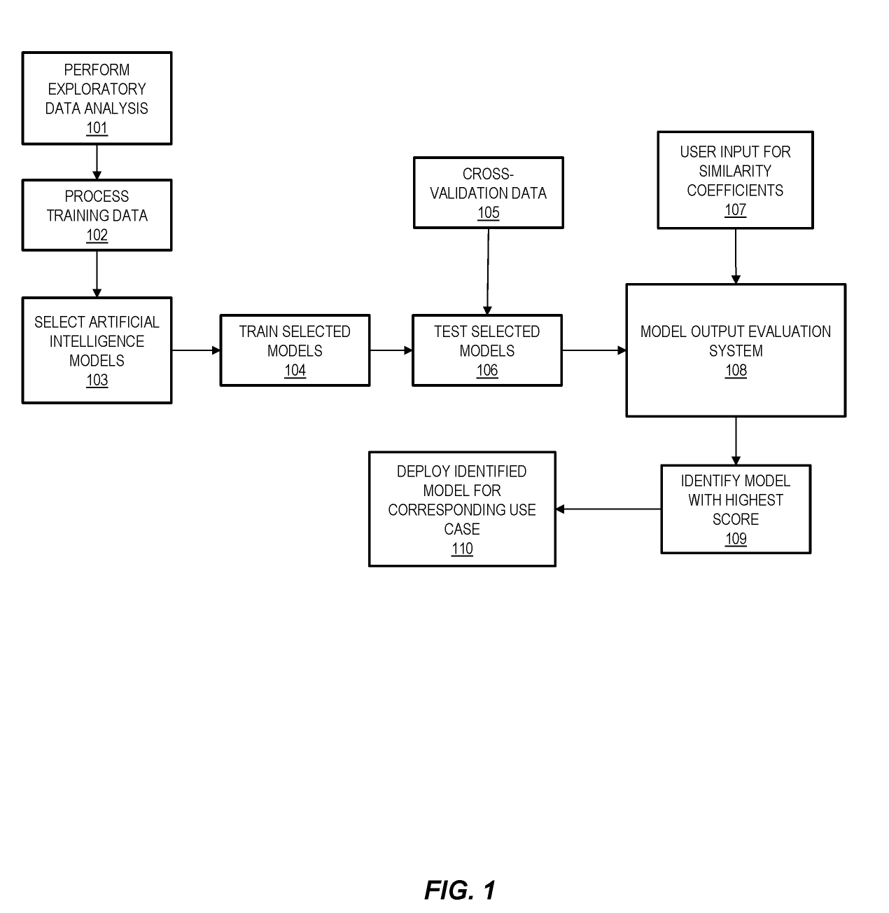

FIG. 1 is a diagram illustrating an example system architecture for artificial intelligence model evaluation, according to an example embodiment of the invention. By way of illustration, FIG. 1 depicts performing exploratory data analysis in step 101, and processing and/or preparing training data in step 102, from among the data obtain in step 101. Additionally, step 103 includes selecting the artificial intelligence models (e.g., one or more LLMs and/or one or more NLP models) to be evaluated. Step 104 includes training the selected models, and step 106 includes testing the selected models in conjunction with cross-validation data 105, which can be used as the testing dataset. Based at least in part on results of the model testing in step 106 and user input for similarity coefficients 107 to be used in the evaluation (e.g., semantic similarity, content similarity, syntactic similarity, contextual similarity, etc.), model output evaluation system 108 evaluates the performance of the selected models. Further, based at least in part on the evaluation performed by model output evaluation system 108, the model with the highest score can be identified in step 109, and that model can be deployed for the corresponding use case in step 110.

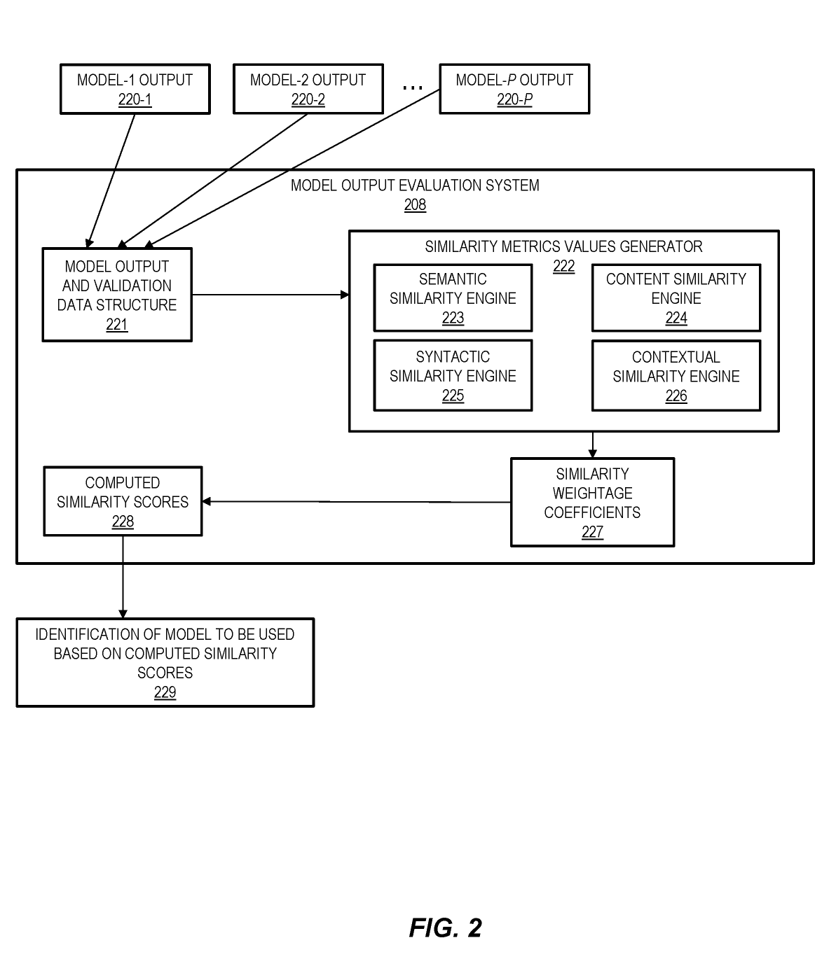

FIG. 2 is a diagram illustrating an example system architecture for model output similarity computations, according to an example embodiment of the invention. By way of illustration, FIG. 2 depicts output for a first artificial intelligence model 220-1, output for a second artificial intelligence model 220-2, and output for artificial intelligence model-P 220-P (referred to collectively as model outputs 220), wherein such model outputs 220 are provided to and/or processed by model output evaluation system 208. More particularly, model output evaluation system 208 processes model outputs 220 and validation data into at least one data structure 221, which is then processed by similarity metrics values generator 222.

As part of similarity metrics values generator 222, semantic similarity engine 223 uses embedding techniques and a cosine similarity function to calculate the semantic similarity of the model outputs 220 and/or the validation data across the multiple artificial intelligence models. Similarly, content similarity engine 224 uses tokenization techniques and a Jaccard similarity function to calculate the content similarity of the model outputs 220 and/or the validation data across the multiple artificial intelligence models, syntactic similarity engine 225 uses positional sequencing techniques and at least one NLP function to calculate the syntactic similarity of the model outputs 220 and/or the validation data across the multiple artificial intelligence models, and contextual similarity engine 226 uses tokenization techniques, contextual embedding techniques, and a cosine similarity function to calculate the contextual similarity of the model outputs 220 and/or the validation data across the multiple artificial intelligence models.

Further, model output evaluation system 208 processes at least a portion of the computations using similarity metrics values generator 222, which provides similarity weightage coefficients 227, and uses the same to apply weights to each of the different similarity scores. Based at least in part thereon, computed similarity scores 228 for the multiple artificial intelligence models can be generated and/or determined. Such computed similarity scores 228 can represent a given model’s combined similarity (e.g., across semantic similarity, content similarity, syntactic similarity, and contextual similarity) across different validation data inputs and/or with respect to each of the other multiple artificial intelligence models. Also, as additionally illustrated in FIG. 2, one or more embodiments can include determining the median similarity score for each of the multiple artificial intelligence models across different validation data inputs, and identifying, in step 229, the model with the highest median similarity score as the model to be used in the conversation system task in question.

For example, consider a scenario with 100 training data points, and that the multiple artificial intelligence models are trained using approximately 80 of those training data points, while approximately 20 of the training data points are withheld and used for validation. Additionally, assume that Model-1 is validated against each of the approximately 20 validation data points, and different similarity scores are achieved across those approximately 20 validation data points. Further, at least one embodiment can include determining and/or taking the median of those approximately twenty similarity scores, and determining and/or reaching a final similarity score for Model-1. Similarly, such an embodiment can include determining and/or reaching a final similarity score for the other of the multiple artificial intelligence models against the same approximately 20 validation data points. Subsequently, a comparison can be carried out among all of the final similarity scores for the multiple artificial intelligence models to determine the best model for the given use case as the model with the highest final similarity score.

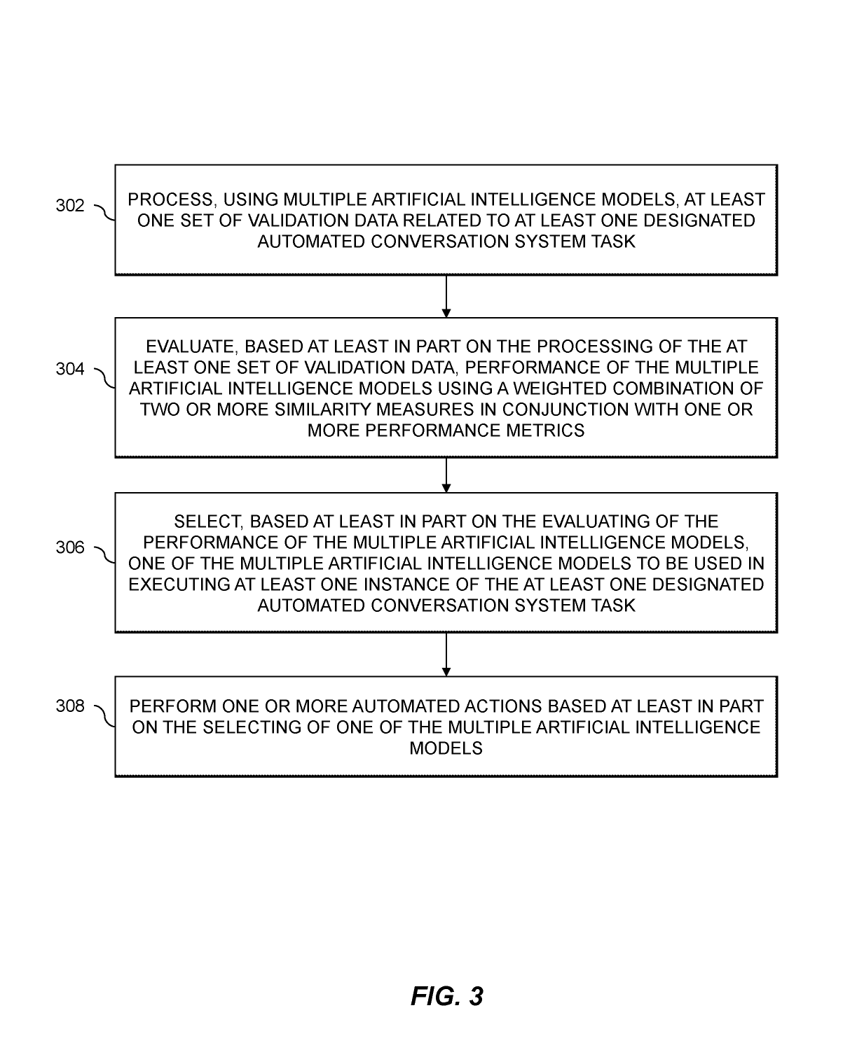

FIG. 3 is a flow diagram illustrating techniques according to an embodiment of the present invention. Step 302 includes processing, using multiple artificial intelligence models, at least one set of validation data related to at least one designated automated conversation system task. In at least one embodiment, the multiple artificial intelligence models include at least one of multiple NLP models and multiple LLMs.

Step 304 includes evaluating, based at least in part on the processing of the at least one set of validation data, performance of the multiple artificial intelligence models using a weighted combination of two or more similarity measures in conjunction with one or more performance metrics. In one or more embodiments, evaluating the performance of the multiple artificial intelligence models includes determining at least one similarity score each of the multiple artificial intelligence models using, in conjunction with the one or more performance metrics, a weighted combination of two or more of a semantic similarity measure, a content similarity measure, a syntactic similarity measure, and a contextual similarity measure. In such an embodiment, determining at least one similarity score each of the multiple artificial intelligence models can include determining a median similarity score for each of the multiple artificial intelligence models across multiple data inputs within the at least one set of validation data.

Also, in one or more embodiments, the one or more performance metrics include one or more intrinsic evaluation metrics comprising one or more of accuracy, precision and recall, AUC, MRR, MAP, RMSE, MAPE, METEOR, F1 score, BLEU, ROUGE, and perplexity. Additionally or alternatively, the one or more performance metrics can include one or more extrinsic evaluation metrics comprising one or more of task-specific accuracy, one or more KPIs, one or more user satisfaction metrics, time and resource efficiency, and ROI.

Step 306 includes selecting, based at least in part on the evaluating of the performance of the multiple artificial intelligence models, one of the multiple artificial intelligence models to be used in executing at least one instance of the at least one designated automated conversation system task. In at least one embodiment, selecting one of the multiple artificial intelligence models can include identifying the artificial intelligence model, among the multiple artificial intelligence models, associated with the highest median similarity score as the artificial intelligence model to be used in executing at least one instance of the at least one designated automated conversation system task.

Step 308 includes performing one or more automated actions based at least in part on the selecting of one of the multiple artificial intelligence models. In one or more embodiments, performing one or more automated actions includes automatically executing the at least one instance of the at least one designated automated conversation system task using the selected one of the multiple artificial intelligence models. Additionally or alternatively, performing one or more automated actions can include generating and outputting, to one or more of at least one user and at least one system associated with the at least one designated automated conversation system task, one or more recommendations related to the selecting of one of the multiple artificial intelligence models.

Further, in at least one embodiment, performing one or more automated actions includes automatically implementing one or more configuration modifications to at least one of the multiple artificial intelligence models based at least in part on the selecting of one of the multiple artificial intelligence models. In such an embodiment, implementing one or more configuration modifications to the at least one of the multiple artificial intelligence models can include one or more of automatically retraining at least a portion of the at least one of the multiple artificial intelligence models, adjusting one or more portions of architecture of the at least one of the multiple artificial intelligence models, fine-tuning one or more parameters of the at least one of the multiple artificial intelligence models, increasing training data associated with the at least one of the multiple artificial intelligence models, adjusting one or more hyperparameters of the at least one of the multiple artificial intelligence models, and implementing transfer learning techniques in connection with the at least one of the multiple artificial intelligence models.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform example method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as artificial intelligence model evaluation code 426. In addition to artificial intelligence model evaluation code 426, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and artificial intelligence model evaluation code 426, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

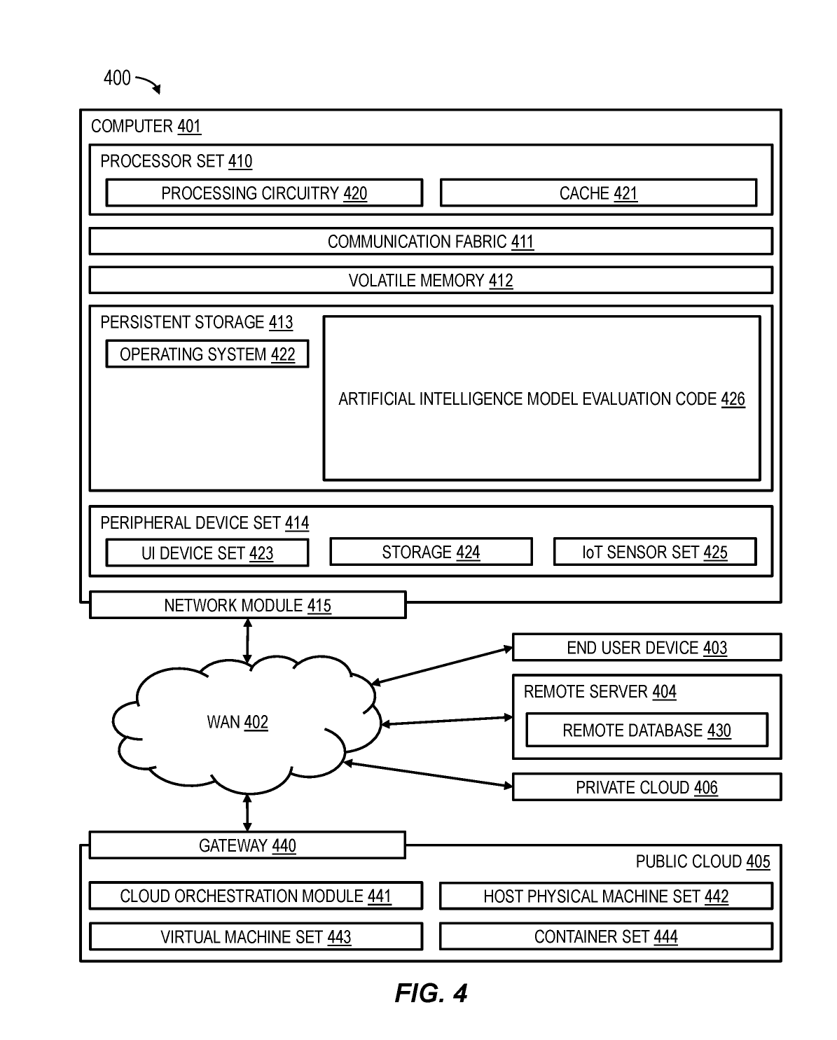

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in artificial intelligence model evaluation code 426 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 412 is any type of volatile memory now known or to be developed in the future. Examples include dynamic type RAM or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a ROM, but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in artificial intelligence model evaluation code 426 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

In computing environment 400, computer 401 is shown as being connected to the internet (see WAN 402). However, in many embodiments of the present invention computer 401 will be isolated from communicating over communications network and not connected to the internet, running as a standalone computer. In these embodiments, network module 415 of computer 401 may not be necessary or even desirable in order to ensure isolation and to prevent external communications coming into computer 401. The standalone computer embodiments are potentially advantageous, at least in some applications of the present invention, because they are typically more secure. In other embodiments, computer 401 is connected to a secure WAN or a secure LAN instead of WAN 402 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
processing, using multiple artificial intelligence models, at least one set of validation data related to at least one designated automated conversation system task;
evaluating, based at least in part on the processing of the at least one set of validation data, performance of the multiple artificial intelligence models using a weighted combination of two or more similarity measures in conjunction with one or more performance metrics;
selecting, based at least in part on the evaluating of the performance of the multiple artificial intelligence models, one of the multiple artificial intelligence models to be used in executing at least one instance of the at least one designated automated conversation system task; and
performing one or more automated actions based at least in part on the selecting of one of the multiple artificial intelligence models;
wherein the method is carried out by at least one computing device.

2. The computer-implemented method of claim 1, wherein evaluating the performance of the multiple artificial intelligence models comprises determining at least one similarity score each of the multiple artificial intelligence models using, in conjunction with the one or more performance metrics, a weighted combination of two or more of a semantic similarity measure, a content similarity measure, a syntactic similarity measure, and a contextual similarity measure.

3. The computer-implemented method of claim 2, wherein determining at least one similarity score each of the multiple artificial intelligence models comprises determining a median similarity score for each of the multiple artificial intelligence models across multiple data inputs within the at least one set of validation data; and
wherein selecting one of the multiple artificial intelligence models comprises identifying the artificial intelligence model, among the multiple artificial intelligence models, associated with the highest median similarity score as the artificial intelligence model to be used in executing at least one instance of the at least one designated automated conversation system task.

4. The computer-implemented method of claim 1, wherein the multiple artificial intelligence models comprise at least one of multiple natural language processing (NLP) models and multiple large language models (LLMs).

5. The computer-implemented method of claim 1, wherein performing one or more automated actions comprises automatically executing the at least one instance of the at least one designated automated conversation system task using the selected one of the multiple artificial intelligence models.

6. The computer-implemented method of claim 1, wherein the one or more performance metrics comprise one or more intrinsic evaluation metrics comprising one or more of accuracy, precision and recall, area under the curve (AUC), mean reciprocal rank (MRR), mean average precision (MAP), root mean squared error (RMSE), mean absolute percentage error (MAPE), a metric for evaluation of translation with explicit ordering (METEOR), F1 score, bilingual evaluation understudy (BLEU), recall-oriented understudy for gisting evaluation (ROUGE), and perplexity.

7. The computer-implemented method of claim 1, wherein the one or more performance metrics comprise one or more extrinsic evaluation metrics comprising one or more of task-specific accuracy, one or more key performance indicators (KPIs), one or more user satisfaction metrics, time and resource efficiency, and return on investment (ROI).

8. The computer-implemented method of claim 1, wherein performing one or more automated actions comprises generating and outputting, to one or more of at least one user and at least one system associated with the at least one designated automated conversation system task, one or more recommendations related to the selecting of one of the multiple artificial intelligence models.

9. The computer-implemented method of claim 1, wherein performing one or more automated actions comprises automatically implementing one or more configuration modifications to at least one of the multiple artificial intelligence models based at least in part on the selecting of one of the multiple artificial intelligence models.

10. The computer-implemented method of claim 9, wherein implementing one or more configuration modifications to the at least one of the multiple artificial intelligence models comprises one or more of automatically retraining at least a portion of the at least one of the multiple artificial intelligence models, adjusting one or more portions of architecture of the at least one of the multiple artificial intelligence models, fine-tuning one or more parameters of the at least one of the multiple artificial intelligence models, increasing training data associated with the at least one of the multiple artificial intelligence models, adjusting one or more hyperparameters of the at least one of the multiple artificial intelligence models, and implementing transfer learning techniques in connection with the at least one of the multiple artificial intelligence models.

11. A computer system comprising:
a processor set;
one or more computer-readable storage media; and
program instructions stored on the one or more computer-readable storage media to cause the processor set to perform operations comprising:
processing, using multiple artificial intelligence models, at least one set of validation data related to at least one designated automated conversation system task;
evaluating, based at least in part on the processing of the at least one set of validation data, performance of the multiple artificial intelligence models using a weighted combination of two or more similarity measures in conjunction with one or more performance metrics;
selecting, based at least in part on the evaluating of the performance of the multiple artificial intelligence models, one of the multiple artificial intelligence models to be used in executing at least one instance of the at least one designated automated conversation system task; and
performing one or more automated actions based at least in part on the selecting of one of the multiple artificial intelligence models.

12. The computer system of claim 11, wherein evaluating the performance of the multiple artificial intelligence models comprises determining at least one similarity score each of the multiple artificial intelligence models using, in conjunction with the one or more performance metrics, a weighted combination of two or more of a semantic similarity measure, a content similarity measure, a syntactic similarity measure, and a contextual similarity measure.

13. The computer system of claim 12, wherein determining at least one similarity score each of the multiple artificial intelligence models comprises determining a median similarity score for each of the multiple artificial intelligence models across multiple data inputs within the at least one set of validation data; and
wherein selecting one of the multiple artificial intelligence models comprises identifying the artificial intelligence model, among the multiple artificial intelligence models, associated with the highest median similarity score as the artificial intelligence model to be used in executing at least one instance of the at least one designated automated conversation system task.

14. The computer system of claim 11, wherein performing one or more automated actions comprises automatically executing the at least one instance of the at least one designated automated conversation system task using the selected one of the multiple artificial intelligence models.

15. The computer system of claim 11, wherein performing one or more automated actions comprises automatically implementing one or more configuration modifications to at least one of the multiple artificial intelligence models based at least in part on the selecting of one of the multiple artificial intelligence models.

16. A computer program product comprising:
one or more computer-readable storage media; and
program instructions stored on the one or more computer-readable storage media to perform operations comprising:
processing, using multiple artificial intelligence models, at least one set of validation data related to at least one designated automated conversation system task;
evaluating, based at least in part on the processing of the at least one set of validation data, performance of the multiple artificial intelligence models using a weighted combination of two or more similarity measures in conjunction with one or more performance metrics;
selecting, based at least in part on the evaluating of the performance of the multiple artificial intelligence models, one of the multiple artificial intelligence models to be used in executing at least one instance of the at least one designated automated conversation system task; and
performing one or more automated actions based at least in part on the selecting of one of the multiple artificial intelligence models.

17. The computer program product of claim 16, wherein evaluating the performance of the multiple artificial intelligence models comprises determining at least one similarity score each of the multiple artificial intelligence models using, in conjunction with the one or more performance metrics, a weighted combination of two or more of a semantic similarity measure, a content similarity measure, a syntactic similarity measure, and a contextual similarity measure.

18. The computer program product of claim 17, wherein determining at least one similarity score each of the multiple artificial intelligence models comprises determining a median similarity score for each of the multiple artificial intelligence models across multiple data inputs within the at least one set of validation data; and
wherein selecting one of the multiple artificial intelligence models comprises identifying the artificial intelligence model, among the multiple artificial intelligence models, associated with the highest median similarity score as the artificial intelligence model to be used in executing at least one instance of the at least one designated automated conversation system task.

19. The computer program product of claim 16, wherein performing one or more automated actions comprises automatically executing the at least one instance of the at least one designated automated conversation system task using the selected one of the multiple artificial intelligence models.

20. The computer program product of claim 16, wherein performing one or more automated actions comprises automatically implementing one or more configuration modifications to at least one of the multiple artificial intelligence models based at least in part on the selecting of one of the multiple artificial intelligence models.
